(19) United States
(12) Patent Application Publication
(10) Pub. No.: US 2022/0128461 A1
(43) Pub. Date: Apr. 28, 2022

(54) PRINTING DEVICES TO CONTROL MOISTURE

(71) Applicant: Hewlett-Packard Development Company, L.P., Spring, TX (US)

(72) Inventors: James M Brenner, Vancouver, WA (US); Loreal E Camp, Vancouver, WA (US)

(73) Assignee: Hewlett-Packard Development Company, L.P., Spring, TX (US)

(21) Appl. No.: 17/294,442

(22) PCT Filed: Jul. 17, 2019
(86) PCT No.: PCT/US2019/042154

§ 371 Date: May 17, 2021

(51) Int. Cl. G01N 21/3559; B41J 11/00

(52) U.S. Cl. CPC G01N 21/3559; B41J 11/0095; B41J 11/00242

(57) ABSTRACT

An example printing device includes: a paper path; a component controllable to cause reduction of moisture along the paper path; a sensor and a reflective surface on opposite sides of the paper path such that paper moves along the paper path between the sensor and the reflective surface, the sensor to: emit light towards the reflective surface; and detect light reflected from the reflective surface; and a processor connected to the sensor and a memory storing instructions, the processor to execute the instructions to cause the processor to: communicate with the sensor to determine that the light detected by the sensor, as reflected from the reflective surface, meets a moisture threshold condition; and in response to determining that the light detected by the sensor meets the moisture threshold condition, control the component to reduce the moisture along the paper path.

### BACKGROUND

As paper moves along a paper path in a printing device, the paper may be heated as part of a printing process, causing the paper to release moisture, which causes moisture and/or condensation to accumulate in the printing device. Sensors that detect presence or absence of the paper along the paper path, and which may be used to detect paper jams, may rely on reflection of light from reflective surfaces, a sensor and a respective reflective surface located on opposite sides of the paper path. As the moisture increases in the printing device, condensation may accumulate on the reflective surface and/or light reflected by the reflective surface towards the sensor may be absorbed by moisture in the air along the paper path, which may lead to a reduction in light detected by the sensor and a false indication of a paper jam.

### BRIEF DESCRIPTION OF THE DRAWINGS

Reference will now be made, by way of example only, to the accompanying drawings in which:

FIG. 1 is a block diagram of an example printing device to control moisture.

FIG. 2 is a graph of sensor indications as a function of time, for example as generated by a sensor of the printing device of FIG. 1.

FIG. 3 is a block diagram of another example printing device to control moisture.

FIG. 4 depicts the printing device of FIG. 3 controlling a component to reduce moisture.

FIG. 5 depicts the printing device of FIG. 3 controlling a component to reduce normal operation.

FIG. 6 is a flowchart of an example of a method to control moisture at a printing device.

### DETAILED DESCRIPTION

As paper moves along a paper path in a printing device, the paper may be heated as part of a printing process, causing the paper to release moisture, which causes moisture and/or condensation to accumulate in the printing device. Sensors that detect presence or absence of the paper along the paper path, and which may be used to detect paper jams, may rely on reflection of light from reflective surfaces, a sensor and a respective reflective surface located on opposite sides of the paper path. As the moisture increases in the printing device, condensation may accumulate on the reflective surface and/or light reflected by the reflective surface towards the sensor may be absorbed by moisture in the air along the paper path, which may lead to a reduction in light detected by the sensor and a false indication of a paper jam.

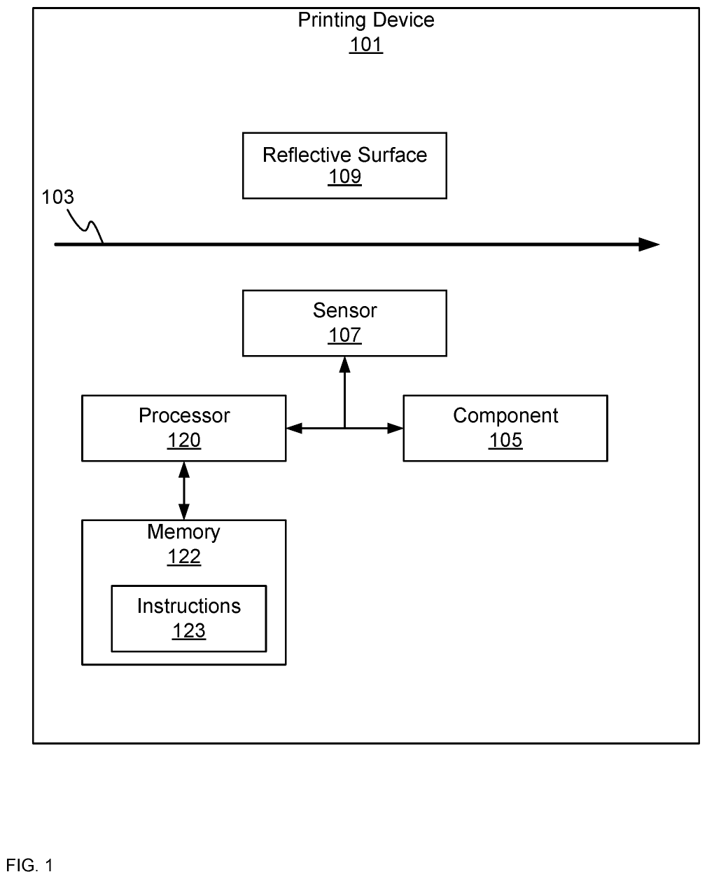

Referring to FIG. 1, a printing device 101 to control moisture therein is provided, the printing device 101 comprising: a paper path 103; a component 105 controllable to cause reduction of moisture along the paper path 103; a sensor 107 and a reflective surface 109 on opposite sides of the paper path 103 such that paper moves along the paper path between the sensor 107 and the reflective surface 109, the sensor 107 to: emit light towards the reflective surface 109; and detect light reflected from the reflective surface 109; and a processor 120 connected to the sensor 107 and a memory 122 storing instructions 123, the processor 120 to execute the instructions 123 to cause the processor 120 to: communicate with the sensor 107 to determine that the light detected by the sensor 107, as reflected from the reflective surface 109, meets a moisture threshold condition; and in response to determining that the light detected by the sensor 107 meets the moisture threshold condition, control the component 105 to reduce the moisture along the paper path 103. Communication between components described herein is shown in the figures of the present specification as arrows therebetween.

The printing device 101 may comprise any suitable device which prints text, images, and the like, onto paper. The printing device 101 may include, but is not limited to, an inkjet printer, a laser printer, and the like. While not depicted, the printing device 101 generally includes printing components, which may be controlled by the processor 120, to print onto the paper, the printing components located along the paper path 103. The printing components may include a heater to heat the paper for printing thereupon and such heating may cause the paper to release moisture, thereby causing moisture to interfere with detection, by the sensor 107, of light reflected by the reflective surface 109. A temperature of the heater may be controlled by the processor 120.

While not depicted, the printing device 101 generally includes mechanical components, which may be controlled by the processor 120, to move the paper along the paper path 103 including, but not limited to, a motor and/or motors and/or rollers. While the paper path 103 is depicted as straight, the paper path 103 may be any suitable shape, for example from an in-tray for the paper to an out-tray for the paper. The mechanical components generally move the paper along the paper path 103 and may, for example, move the paper in a manner that cause the paper to reverse direction, and the like. The mechanical components may include a portion of the printing components; for example, a roller of the mechanical components may also include the heater of the printing components (e.g. a heated roller).

The mechanical components and/or the printing components may also be to control a rate of movement of the paper along the paper path 103 to cause reduction of the moisture along the paper path 103, for example, as controlled by the processor 120; and/or mechanical components and/or the printing components may be to pause movement of the paper along the paper path 103 to cause reduction of the moisture along the paper path 103, for example, as controlled by the processor 120. For example, the mechanical components may include a motor controlled by the processor 120; the motor may comprise an electric motor and/or a stepper motor, which may be to control a rate of paper along the paper path and/or to pause movement of the paper along the paper path 103. For example, the motor may control a roller and/or rollers which move the paper along the paper path 103.

The component 105 may comprise any suitable component of the printing device 101 that may be used to control moisture along the paper path 103. As such, the component 105 may interchangeably referred to as a moisture control component 105, though moisture control may not be the only function of the component 105.

In some examples, the component 105 may comprise a fan and/or fans which generally move air through the printing device 101 to remove moisture from the printing device, and/or to control heat within the printing device 101. In some examples, a speed of a fan may be controlled, for example by the processor 120. For example, the processor 120 may be to: increase a speed of the fan to control the component 105 of the printing device 101 to cause reduction of the moisture along the paper path 103. In other words, the speed of the fan may be at least temporarily increased to increase a moisture removal rate along the paper path 103.

The component 105 may comprise a heater (e.g. of the printing components) to heat the paper for printing thereupon which may be controlled by the processor 120 to cause reduction of the moisture along the paper path 103. For example, the processor 120 may be to: lower a temperature of the heater to control the component 105 of the printing device 101 to cause reduction of the moisture along the paper path 103. In other words, the temperature of the heater may be at least temporarily decreased to cause reduction of the moisture along the paper path, for example by at least temporarily reducing an amount of water emitted by the paper moving through the printing device 101 due to the reduction in a heating temperature; in general, however, the heater may not be lowered below a threshold temperature for printing so as to not impact a quality of the printing.

The component 105 may be to control a rate of movement of the paper along the paper path 103 to cause reduction of the moisture along the paper path 103. For example, the component 105 may comprise a motor and/or a roller (e.g. of the mechanical components and/or the printing components) that controls a rate of movement of the paper along the paper path 103 and/or pauses movement of the paper along the paper path 103. For example, when the moisture along the paper path 103 is due to movement and/or presence of paper and/or heated paper along the paper path 103, lowering a rate of movement of the paper along the paper path 103, and/or pausing movement of the paper along the paper path 103, may result in the moisture being lowered. For example, lowering a rate of movement of the paper and/or pausing movement of the paper along the paper path 103 may provide time for the moisture to naturally dissipate and/or to allow time for a fan to dissipate the moisture. Indeed, the printing device 101 may comprise a fan that may not be controlled by the processor 120 and/or whose speed may not be controlled by the processor 120, but is always on and set to a speed that is intended to remove moisture from the printing device 101 at a removal rate greater than an accumulation rate due to paper moving along the paper path 103. However, when the accumulation rate of the moisture exceeds the removal rate of the moisture by the fan, lowering and/or pausing a rate of movement of the paper along the paper path 103 may allow time for the fan to “catch up” with removing the moisture from the printing device 101; for example lowering and/or pausing a rate of movement of the paper along the paper path 103 may at least temporarily reduce the accumulation rate of the moisture.

In general, the combination of the sensor 107 and the reflective surface 109 is used to detect presence and absence of paper therebetween, for example to detect edges of paper moving along the paper path 103, trailing edges of the paper and/or to detect leading edges of the paper, and/or to detect paper jams along the paper path 103. For example, while FIG. 1 depicts only one combination of a sensor 107 and reflective surface 109, the printing device 101 may comprise a plurality of sensors 107 (e.g. in communication with the processor 120) and associated reflective surfaces 109 along the paper path 103, for example to track movement of paper along the paper path 103 and/or to detect paper jams therein.

The sensor 107 may comprise a combination of a light emitter (e.g. a light emitting diode (LED), and a light sensor (e.g. a photoelectric device and/or a photo transistor). The light emitter emits light towards the reflective surface 109, which reflects the light back to the sensor 107 for detection by the light sensor, to detect presence and absence of paper therebetween.

The sensor 107 may provide a binary indication to the processor 120 (e.g. a “1” or a “0”) to indicate presence and absence of paper between the sensor 107 and the reflective surface 109. However, the sensor 107 may also provide an indication to the processor 120 of an intensity of the light detected by the sensor 107. In some examples, as the intensity of the light increases, the indication of the sensor 107 increases, and as the intensity of the light decreases, indication of the sensor 107 decreases.

However, in other examples, as described herein, the sensor 107 may include an inverted circuit such that, as the intensity of the light increases, the indication of the sensor 107 decreases, and as the intensity of the light decreases, the indication of the sensor 107 increases.

The indication of intensity of the light may depend on a scale of electronics of the sensor 107; for example, the indication may be provided on a 9 bit scale, such that the indication comprises a value between 0 and 511 (e.g. 512 values). However, any suitable indication of intensity of light detected by the sensor 107 is within the scope of the present specification.

The sensor 107 may be preconfigured with a threshold condition for detecting presence or absence of paper. For example, the sensor 107 may return a digital and/or binary indication (e.g. “0” or “1”) to the processor 120 of absence of paper between the sensor 107 and the reflective surface 109 when the indication of intensity of the light does not meet the threshold condition (e.g. the indication of intensity of the light is below or above a threshold value, depending on whether the indication of intensity of the light decreases or increases as the intensity of the light decreases). Similarly, the sensor 107 may return a digital and/or binary indication (e.g. “1” or “0”) to the processor 120 of presence of paper between the sensor 107 and the reflective surface 109 when the indication of intensity of the light does not meet the threshold condition (e e.g. the indication of intensity of the light is above or below a threshold value, depending on whether the indication of intensity of the light increases or decreases as the intensity of the light increases).

The threshold value may be determined during a calibration of the printing device 101, and/or an intensity of light detected by the sensor 107 in the absence of paper may be determined during the calibration. For example, during calibration, the intensity of light emitted by the sensor 107 with no paper between the sensor 107 and the reflective surface 109 may be adjusted such that the indication of intensity of the light detected by the sensor 107 is at a given value such that, when paper is between the sensor 107 and the reflective surface 109, the indication of intensity of the light is at a minimum or maximum value (depending on whether the indication of intensity of the light decreases or increases as the intensity of the light decreases, and/or whether the sensor includes an inverted circuit).

Regardless, when light is detected at the sensor 107, as reflected by the reflective surface 109, the processor 120 may determine, via data received from the sensor 107 indicating such light detection, that no paper is between the sensor 107 and the reflective surface 109. However, when no light is detected at the sensor 107, as reflected by the reflective surface 109, the processor 120 may determine, via data received from the sensor 107 indicating such lack of light detection, that paper is between the sensor 107 and the reflective surface 109.

Changes in the data received from the sensor 107, showing a change from light detected to no light detected, may indicate to the processor 120 that a leading edge (e.g. a leading paper edge) of paper has been detected. Similarly, changes in the data received from the sensor 107 showing a change from no light detected to light detected, may indicate to the processor 120 that a trailing edge (e.g. a trailing paper edge) of paper has been detected.

However, moisture along the paper path 103 may interfere with the light detection, leading to incorrect determinations by the processor 120 of leading edges and/or trailing edges and/or incorrect determinations of presence or absence of paper between the sensor 107 and the reflective surface 109, which may cause the processor 120 to incorrectly determine that a paper jam is occurring.

For example, the sensor 107 may emit light in a near infrared (NIR) range of light, such as at about a 940 nm wavelength, which may be absorbed by moisture in the air along the paper path 103, for example as reflected by the reflective surface 109. The reflective surface 109 may comprise a mirror, and/or polished metal and/any suitable type of reflective surface to reflect light from the sensor 107 back to the sensor 107. Moisture along the paper path 103 may accumulate on the reflective surface 109 as condensation, which may scatter the light received from the sensor 107.

One or both of absorption of the light reflected by the reflective surface 109 and scattering of the light at the reflective surface 109 may occur due to moisture along the paper path 103, which may lead to a reduction in light detected at the sensor 107. Such a reduction may change the data provided to the processor 120, and may cause the processor 120 to make an incorrect determination of presence of the paper between the sensor 107 and the reflective surface 109 which may cause the processor 120 to make an incorrect determinations of a paper jam occurring along the paper path 103. Such an incorrect determinations of a paper jam may cause the processor 120 to undergo a paper jam remedial action to attempt to clear the paper jam, which may damage the printing device 101, and/or to control a notification device that a paper jam has occurred. Either situation may further waste processing resources of the printing device 101 and/or slow printing at the printing device 101.

However, by the processor 120 communicating with the sensor 107 to determine that the light detected by the sensor 107, as reflected from the reflective surface 109, meets a moisture threshold condition, the processor 120 may responsively control the component 105 to reduce moisture along the paper path 103 to reduce a possibility of an incorrect determination of a paper jam.

The moisture threshold condition may comprise a given intensity of the light reflected by the reflective surface 109, as detected by the sensor 107, and/or the moisture threshold condition may comprise a rate of change of the light reflected by the reflective surface 109, as detected by the sensor 107. The moisture threshold condition may be determined heuristically and stored at the memory 122, for example at the instructions 123 and/or separate from the instructions 123. Alternatively, the moisture threshold condition may be based on a calibration of the printing device 101 as described hereafter.

When the moisture threshold condition comprises a given intensity of the light reflected by the reflective surface 109, the given intensity of the light may be indicated by a respective given value that may depend on whether the indication of intensity of the light, from the sensor 107, increases or decreases as the intensity of the light decreases. For example, when the indication of intensity of the light, from the sensor 107, increases as the intensity of the light decreases, the respective given value may be greater than the given value to which the sensor 107 is set during calibration (e.g. when no paper is between the sensor 107 and the reflective surface 109). However, when the indication of intensity of the light, from the sensor 107, decreases as the intensity of the light decreases, the respective given value may be less than the given value to which the sensor 107 is set during calibration (e.g. when no paper is between the sensor 107 and the reflective surface 109). The respective given value of the moisture threshold condition may be set to a given value above or below the given value to which the sensor 107 is set during calibration (e.g. when no paper is between the sensor 107 and the reflective surface 109), but below the maximum or minimum value returned by the sensor 107 when paper is between the sensor 107 and the reflective surface 109.

Similarly, when the moisture threshold condition comprises a rate of the light reflected by the reflective surface 109, the rate may depend on whether the indication of intensity of the light, from the sensor 107, increases or decreases as the intensity of the light decreases. For example, when the indication of intensity of the light, from the sensor 107, increases as the intensity of the light decreases, the rate of the moisture threshold condition may be positive (e.g. the indication increases). However, when the indication of intensity of the light, from the sensor 107, decreases as the intensity of the light decreases, the rate of the moisture threshold condition may be negative (e.g. the indication decreases).

The processor 120 may include a central processing unit (CPU), a microcontroller, a microprocessor, a processing core, a field-programmable gate array (FPGA), or similar. The processor 120 and memory 122 may cooperate to execute various instructions such as the instructions 123.

The memory 122 is coupled to the processor 120 and may include a non-transitory machine-readable storage medium that may be any electronic, magnetic, optical, or other physical storage device. The non-transitory machine-readable storage medium may include, for example, random access memory (RAM), electrically-erasable programmable read-only memory (EEPROM), flash memory, a storage drive, an optical disc, and the like. The memory 122 may also be encoded with executable instructions to operate other hardware in communication with the processor 120. In other examples, it is to be appreciated that the memory 122 may be substituted with a cloud-based storage system.

The memory 122 may also store an operating system and/or firmware that is executable by the processor 120 to provide general functionality to the printing device 101, for example, functionality to support various applications such as a user interface to access various features of the printing device 101 and/or a paper jam remedial action application. Examples of operating systems include Windows™, macOS™, iOS™, Android™, Linux™, and Unix™. The memory 122 may additionally store applications that are executable by the processor 120 to provide specific functionality to the printing device 101, such as those described in greater detail below and which may include the instructions 123.

In addition, the printing device 101 may include any other suitable components for printing, and/or for receiving print jobs used to control printing components to print onto the paper along the paper path 103, including, but not limited to, a network interface, and the like.

The printing device 101 may also include a notification device, such as a display screen, a speaker, a light, and the like, the notification device controlled by the processor 120, for example to indicate control of the component 105 to reduce moisture. For example, when the component 105 is controlled to reduce moisture in the printing device 101, the processor 120 may control the notification device to provide a notification that the printing device 101 is undergoing a moisture reduction cycle; such a notification may indicate a corresponding slowing and/or pausing of printing and/or a corresponding increase in a fan speed and/or a corresponding reduction in heater temperature, and the like.

As described above, the instructions 123 are generally to cause the processor 120 to: communicate with the sensor 107 to determine that the light detected by the sensor 107, as reflected from the reflective surface 109, meets a moisture threshold condition; and in response to determining that the light detected by the sensor 107 meets the moisture threshold condition, control the component 105 to reduce the moisture along the paper path 103.

In some examples, when the component 105 is to control a rate of movement of the paper along the paper path 103 to cause reduction of the moisture along the paper path 103, the instructions may be further to cause the processor 120 to: in response to determining that the light detected by the sensor 107 meets the moisture threshold condition, control the component 105 to slow the rate of movement of the paper along the paper path 103 to cause reduction of the moisture along the paper path 103, until the light detected by the sensor 107 meets a lowered moisture threshold condition.

The lowered moisture threshold condition may comprise a second given intensity of the light reflected by the reflective surface 109 (e.g. different from the given intensity of the moisture threshold condition), as detected by the sensor 107, and/or the lowered moisture threshold condition may comprise a second rate of change of the light reflected by the reflective surface 109 (e.g. different from the rate of the moisture threshold condition), as detected by the sensor 107. The lowered moisture threshold condition may be determined heuristically and stored at the memory 122, for example at the instructions 123 and/or separate from the instructions 123. However, the lowered moisture threshold condition be a given value above or below the respective given value of the moisture threshold condition.

When the lowered moisture threshold condition comprises a second given intensity of the light reflected by the reflective surface 109, the second given intensity of the light may depend on whether the indication of intensity of the light, from the sensor 107, increases or decreases as the intensity of the light decreases. For example, when the indication of intensity of the light, from the sensor 107, increases as the intensity of the light decreases, the second given intensity may be less than the given intensity of the moisture threshold condition (e.g. by a given amount). Similarly, when the indication of intensity of the light, from the sensor 107, decreases as the intensity of the light decreases, the second given intensity may be greater than the given intensity of the moisture threshold condition (e.g. by a given amount).

When the lowered moisture threshold condition comprises a second rate of the light reflected by the reflective surface 109, the second rate may depend on whether the indication of intensity of the light, from the sensor 107, increases or decreases as the intensity of the light decreases. For example, when the indication of intensity of the light, from the sensor 107, increases as the intensity of the light decreases, the second rate may be less than the rate of the moisture threshold condition (e.g. the second rate may be negative while the rate of the moisture threshold condition may be positive). Similarly, when the indication of intensity of the light, from the sensor 107, decreases as the intensity of the light decreases, the second rate may be greater than the rate of the moisture threshold condition (e.g. the second rate may be positive while the rate of the moisture threshold condition may be negative).

In some examples, when the component 105 is to pause movement of the paper along the paper path 103 to cause reduction of the moisture along the paper path 103, the instructions 123 may be further to cause the processor 120 to: in response to determining that the light detected by the sensor 107 meets the moisture threshold condition, control the component 105 to pause movement of the paper along the paper path 103 to cause reduction of the moisture along the paper path 103, until the light detected by the sensor 107 meets the lowered moisture threshold condition, as described above.

In some examples, when the component 105 comprises a heater to heat the paper for printing thereupon, the instructions 123 may be further to cause the processor 120 to: lower a temperature of the heater to control the component 105 of the printing device 101 to cause reduction of the moisture along the paper path 103. For example, the temperature of the heater may be lowered until the light detected by the sensor 107 meets the lowered moisture threshold condition.

In some examples, when the component 105 comprises a fan, the instructions 123 may be further to cause the processor 120 to: increase a speed of the fan to control the component 105 of the printing device 101 to cause reduction of the moisture along the paper path 103. For example, the speed of the fan may be increased until the light detected by the sensor 107 meets the lowered moisture threshold condition.

In some examples, when the component 105 comprises a fan, and the moisture threshold condition comprises a rate of change of the light detected at the sensor 107, the instructions 123 may be further to cause the processor 120 to: control a speed of the fan as a function of the rate of change of the light detected by the sensor 107 to control the component 105 of the printing device 101 to cause reduction of the moisture along the paper path 103. Hence, for example, the speed of the fan may be controlled track the rate of change the light detected by the sensor 107 which may lead more efficient use of resources at the printing device 101 and/or a more efficient rate of removal of the moisture.

In some examples, the instructions 123 may be further to cause the processor 120 to: communicate with the sensor 107 to determine that a trailing paper edge has passed the sensor 107 and the reflective surface 109, the sensor 107 to: emit light towards the reflective surface 109 along the paper path 103 of the printing device 101; and detect the light reflected from the reflective surface 109, the sensor 107 and the reflective surface 109 on opposite sides of the paper path 103 such that paper moves along the paper path 103 between the sensor 107 and the reflective surface 109; after the trailing paper edge is detected, communicate with the sensor 107 to determine that the light detected by the sensor 107, as reflected by the reflective surface 109, meets a moisture threshold condition; and, in response, control the component 105 of the printing device 101 to cause reduction of the moisture along the paper path 103, as described above. In other words, in these examples, control of the component 105 by the processor 120 may depend on detection of light by the sensor 107 after a trailing paper edge is detected.

In some of these examples, for example when the moisture threshold condition comprises a rate of change of the light detected by the sensor 107, the instructions 123 may be further to cause the processor 120 to: after each of a plurality of trailing paper edges are detected, communicate with the sensor 107 to determine a respective rate of change of the light detected by the sensor 107; and, in response, control the component 105 of the printing device 101 as a function of the respective rate of change of the light to cause reduction of the moisture along the paper path 103. For example, a speed of a fan may be controlled as a function of the respective rate of change of the light and/or a rate of movement of paper along the paper path 103 may be controlled as a function of the respective rate of change of the light.

In more specific examples, the component 105 may comprise a motor to control a rate of paper along the paper path 103, as described above. As also described above, the sensor 107 and the reflective surface 109 are on opposite sides of the paper path 103 such that paper moves along the paper path 103 between the sensor 107 and the reflective surface 109. As also described above the sensor 107 is to: emit light towards the reflective surface 109; and detect light reflected from the reflective surface 109. Hence, when the paper moves along the paper path 103, the paper intermittently interrupts the light reflected by the reflective surface 109 to the sensor 107. Such intermittent interruption may be used to detect absence or presence of paper between the sensor 107 and the reflective surface 109 and hence detect a leading paper edge and/or a trailing paper edge of the paper.

In some of these examples, the instructions 123 may be further to cause the processor 120 to: after trailing edges of the paper are detected by the sensor 107 via a change in the light detected at the sensor 107, communicate with the sensor 107 to determine that the light detected by the sensor 107, as reflected by the reflective surface 109, meets a first moisture threshold condition (e.g. the moisture threshold condition as described above); and in response to determining that the light detected by the sensor 107 meets the first moisture threshold condition, control the motor to reduce the rate of the paper along the paper path 103 or pause the paper along the paper path 103, to reduce the moisture along the paper path 103, until the light detected by the sensor 107, as reflected by the reflective surface 109, meets a second moisture threshold condition (e.g. the lowered moisture threshold condition as described above). When it is determined that the light detected by the sensor 107, as reflected by the reflective surface 109, meets the second moisture threshold condition, the motor may be controlled to return the rate of the paper along the paper path 103 back to a normal rate (e.g. the rate of movement prior to reduction of the rate and/or pausing of the paper).

For example, the first moisture threshold condition may comprise a first given intensity of the light detected by the sensor 107, and the second moisture threshold condition may comprise a second given intensity of the light detected by the sensor 107, the second given intensity indicative of more of the light reflected by the reflective surface 109 than the first given intensity.

In other examples, the first moisture threshold condition may comprise a first rate of change of the light detected by the sensor 107, and the second moisture threshold condition may comprise a second rate of change of the light detected by the sensor 107, the first rate of change of the light detected by the sensor 107 indicative of a decrease of the light reflected by the reflective surface 109 and the second rate of change of the light detected by the sensor 107 indicative of an increase of the light reflected by the reflective surface 109.

In yet further examples, the instructions 123 may be further to cause the processor 120 to: control the motor to control the rate of the paper along the paper path 103 as a function of a rate of change of the light detected by the sensor 107, as reflected by the reflective surface 109. Hence, for example, the speed of the motor may be controlled track the rate of change the light detected by the sensor 107 which may lead more efficient use of resources at the printing device 101 and/or a more efficient rate of removal of the moisture.

In examples where the printing device 101 comprises a notification device, the instructions 123 may be further to cause the processor 120 to: control the notification device to indicate control of the motor to reduce the moisture along the paper path 103.

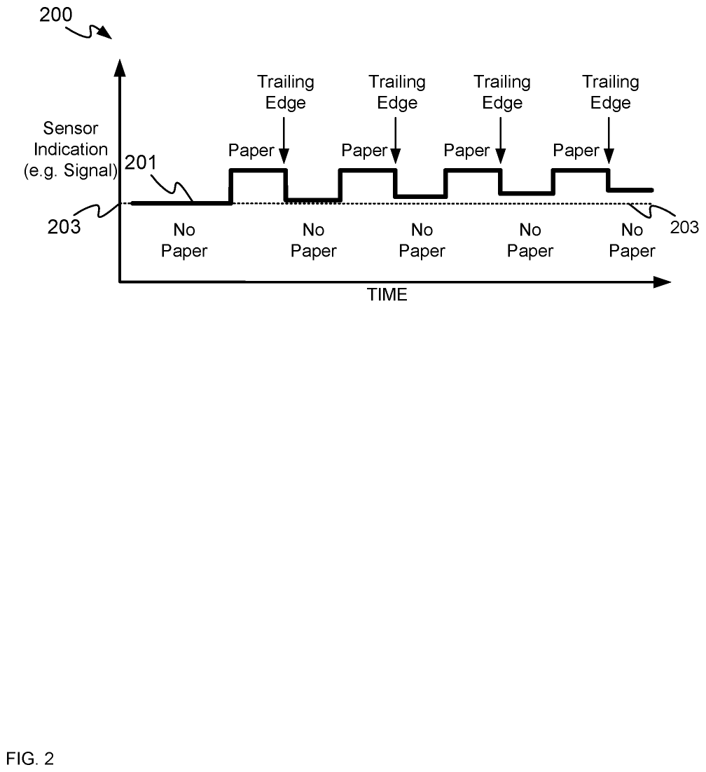

Attention is next directed to FIG. 2 which depicts example indications from the sensor 107 received by the processor 120 to indicate absence and presence of paper along the paper path 103. In particular, FIG. 2 depicts a graph 200 of sensor indications (e.g. a sensor signal) as a function of time. From the graph 200, it is understood that in the depicted example, the sensor 107 includes an inverted circuit such that the sensor indications increase when the light detected by the sensor 107 decreases, and vice versa. As such, sensor indication values in regions of the graph 200 that correspond to an absence of paper (e.g. labelled “NO PAPER” in FIG. 2) are lower than sensor indication values in regions of the graph 200 that correspond to a presence of paper (e.g. labelled “PAPER” in FIG. 2).

Regions where a “paper-present” sensor indication falls to a “no-paper” sensor indication correspond to a trailing edge of paper; while not depicted, an opposite side of the paper-present sensor indications correspond to a leading edge of the paper.

In general, as a reaction time of the sensor 107 may be fast and/or much faster than a rate of movement of the paper along the paper path 103, the graph 200 comprises a generally square wave, with sudden changes between the paper-present and no-paper indications occurring at the leading and trailing edged of the paper. In some examples, such indications may be provided directly to firmware of the printing device 101 (however converted to binary data, such as a “1” or a “0”) for faster detection of a paper jam (e.g. the firmware being processed by the processor 120).

As depicted, an initial no-paper sensor indication 201 is at a given value 203; however, as moisture builds up along the paper path 103, for example due the paper moving along the paper path 103, subsequent no-paper sensor indications, which follow paper-present indications, increase to above the value 203, and continues to increase after each detected trailing paper edge. The processor 120 may monitor the no-paper sensor indications to determine when a no-paper sensor indication meet a moisture threshold condition (e.g. the no-paper sensor indications are above a moisture threshold value); and/or the processor 120 may monitor a rate of increase and/or a rate of change of the no-paper sensor indications to determine when the rate of increase and/or the rate of change meets a moisture threshold condition (e.g. the no-paper sensor indications are increasing at a given rate). When the no-paper sensor indication(s) meet a moisture threshold condition, the processor 120 may control the component 105 accordingly to reduce moisture in the printing device 101.

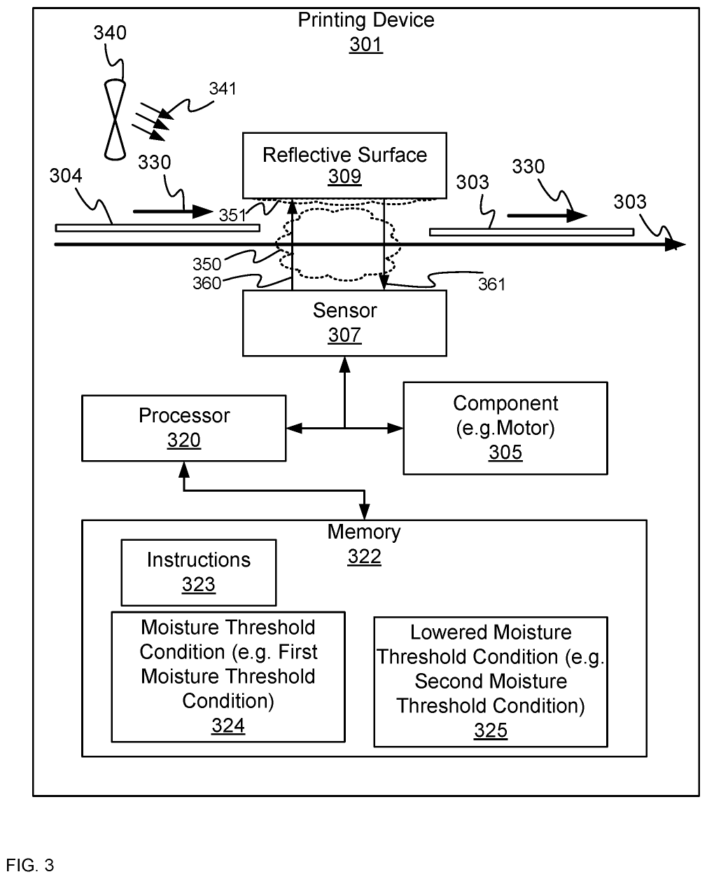

Attention is next directed to FIG. 3 which depicts another printing device 301 to control moisture therein. The printing device 301 is substantially similar to the printing device 101, with like components having like numbers, however in a “300” series rather than a “100” series.

The printing device 301 comprises: a paper path 303; a component 305 controllable to cause reduction of moisture along the paper path 303 (e.g. as depicted, the component 305 may comprise a motor to control a rate of paper 304 along the paper path 303); a sensor 307 and a reflective surface 309 on opposite sides of the paper path 303 such that the paper 304 moves along the paper path 303 between the sensor 307 and the reflective surface 309, the sensor 307 to: emit light towards the reflective surface 309; and detect light reflected from the reflective surface 309; the paper 304 that moves along the paper path 303 to intermittently interrupt the light reflected by the reflective surface 309 to the sensor 307 (e.g. as shown in FIG. 2); and a processor 320 connected to the sensor 307 and a memory 322 storing instructions 323, a moisture threshold condition 324 (e.g. a first moisture threshold condition) and a lowered moisture threshold condition 325 (e.g. a second moisture threshold condition), the processor 320 to execute the instructions 323 to cause the processor 320 to: after trailing edges of the paper 304 are detected by the sensor 307 via a change in the light detected at the sensor 307 (e.g. as depicted in FIG. 2), communicate with the sensor 307 to determine that the light detected by the sensor 307, as reflected by the reflective surface 309, meets a first moisture threshold condition (e.g. the moisture threshold condition 324); and in response to determining that the light detected by the sensor 307 meets the first moisture threshold condition, control the component 305 (e.g. the motor) to reduce the rate of the paper 304 along the paper path 303 or pause the paper 304 along the paper path 303, to reduce the moisture along the paper path 303, until the light detected by the sensor 307, as reflected by the reflective surface 309, meets a second moisture threshold condition (e.g. the lowered moisture threshold condition 325).

FIG. 3 hence depicts the paper 304 moving along the paper path 303, for example as indicated by the arrow 330.

As depicted, the printing device 301 further comprises a fan 340 which blows air 341 through the printing device 301 and in particular between the sensor 307 and the reflective surface 309. For example, FIG. 3 further depicts moisture 350 in the air between the sensor 307 and the reflective surface 309 which may be due to the paper 304 releasing the moisture 350 as a result of being heated by a heater (not depicted) of the printing device 301, as described above, with respect to the printing device 101. FIG. 3 further depicts moisture 351 that may have accumulated at reflective surface 309, for example as condensation, as also released by the paper 304. The air 341 from the fan 340 may be used to remove the moisture 350 and/or the moisture 351, however when the rate of accumulation of the moisture 350 and/or the moisture 351 is larger than a rate of removal by the fan 340, the moisture 350 and/or the moisture 351 may change intensity of light detected by the sensor 307 as described above. For example, as depicted, the sensor 307 is emitting light 360 towards the reflective surface 309 which is reflected back to the sensor 307 for detection, as reflected light 361. The moisture 350 and/or the moisture 351 may absorb the light 360, 361 and/or the moisture 350 and/or the moisture 351 may scatter the light 360, 361 leading to an increase (and/or a change) in the no-paper indications from the sensor 307, as depicted in FIG. 2.

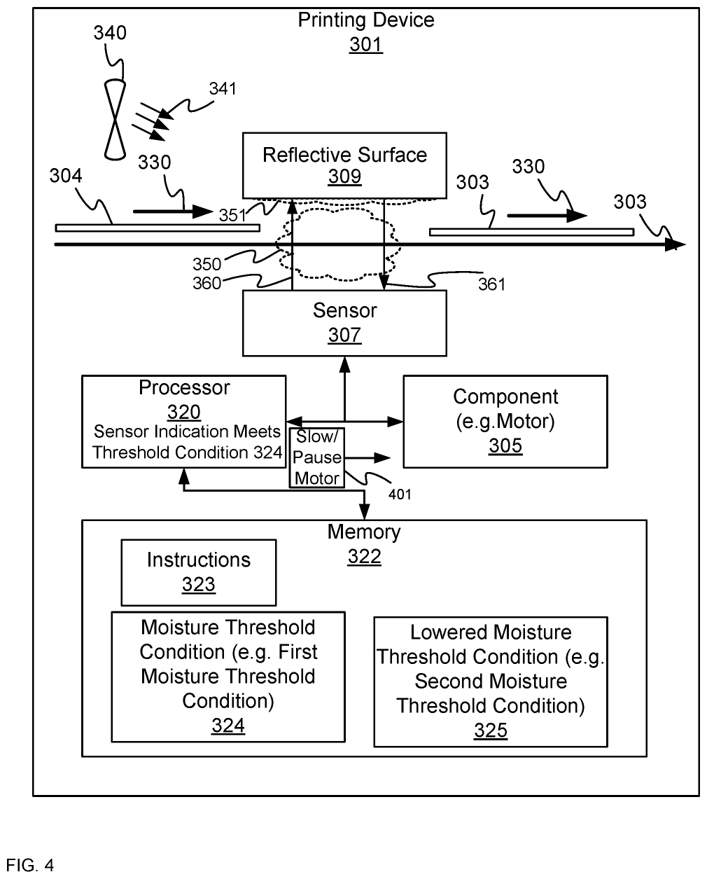

Hence, as depicted in FIG. 4, which is substantially similar to FIG. 3, with like components having like numbers, the processor 320, in response to determining that the light 361 (e.g. the reflected light 361) detected by the sensor 307 meets the first moisture threshold condition 324, the processor 320 controls the component 305 (e.g. the motor) to reduce the rate of movement of the paper 304 along the paper path 303 and/or the processor 320 controls the component 305 (e.g. the motor) to pause the paper 304 along the paper path 303.

For example, as depicted in FIG. 4, the processor 320 transmits a command 401 to the component 305 (e.g. the motor) to reduce (e.g. slow) the rate of the paper 304 along the paper path 303 or pause the rate of the paper 304 along the paper path 303. Such a reduction in movement of the paper 304 and/or pausing of the paper 304 may allow the air 341 from the fan 340 to remove and/or reduce the moisture 350, 351. The reduction in the rate of movement and/or pausing of the paper 304 may be maintained until the light 361 detected by the sensor 307 meets a second moisture threshold condition 325. Put another way, the processor 320 continues to monitor the sensor indication to determine when the light 361 (e.g. the reflected light 361) detected by the sensor 307 meets the second moisture threshold condition 325.

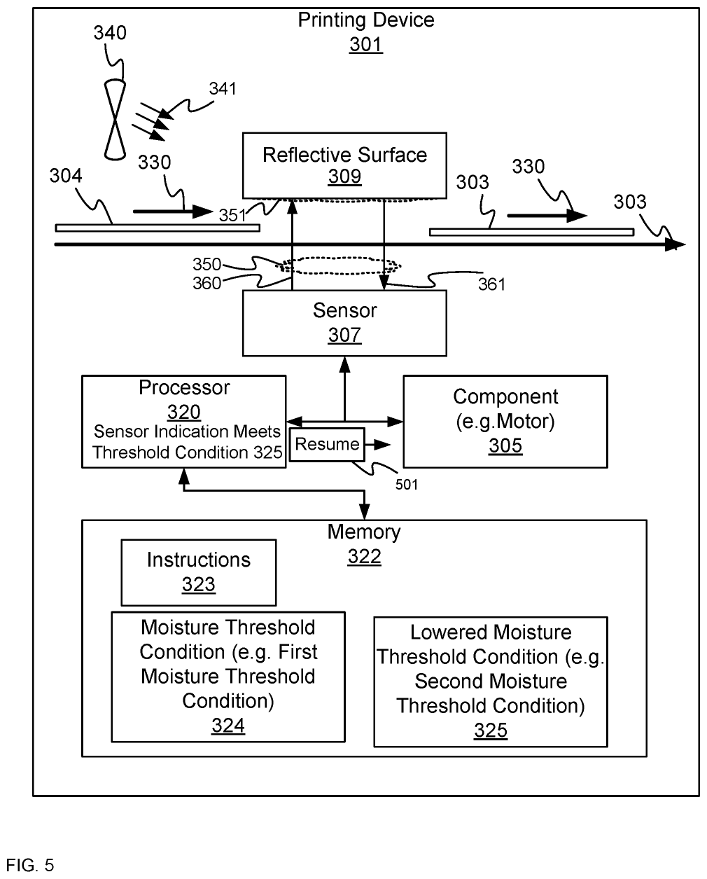

For example, as depicted in FIG. 5, which is substantially similar to FIG. 4, with like components having like numbers, the moisture 350, 351 is depicted as being less than in FIG. 4 and hence the light 361 (e.g. the reflected light 361) detected by the sensor 307 meets the second moisture threshold condition 325.

In response to determining that the light 361 (e.g. the reflected light 361) detected by the sensor 307 meets the second moisture threshold condition 325 (e.g. after the command 401 is transmitted), for example, due to the reduction in the moisture 350, 351, the processor 320 controls the component 305 (e.g. the motor) to resume normal operation, for example to increase the rate of the paper 304 along the paper path 303 and/or to the processor 320 controls the component 305 (e.g. the motor) to resume movement of the paper 304 along the paper path 303. For example, as depicted in FIG. 5, the processor 320 transmits a command 501 to the component 305 (e.g. the motor) to resume normal operation.

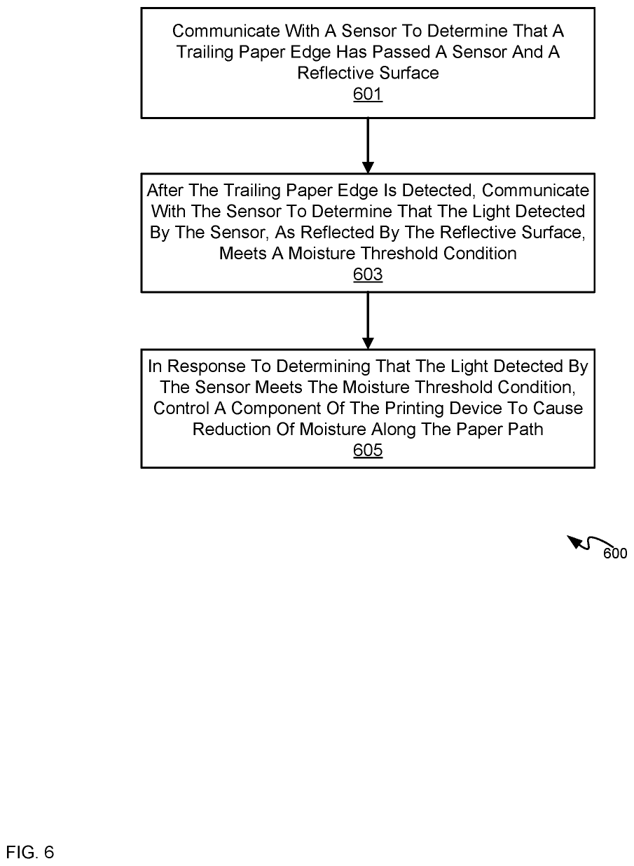

Referring to FIG. 6, a flowchart of a method 600 to control moisture at a printing device. In order to assist in the explanation of method 600, it will be assumed that method 600 may be performed with the printing device 301, and specifically by the processor 320 implementing the instructions 323. Indeed, the method 600 may be one way in which printing device 301 may be configured. Furthermore, the following discussion of method 600 may lead to a further understanding of the printing device 301 and its various components. Furthermore, it is to be emphasized, that method 600 may not be performed in the exact sequence as shown, and various blocks may be performed in parallel rather than in sequence, or in a different sequence altogether. It is further understood that the method 600 may be performed with the printing device 101, and specifically by the processor 120 implementing the instructions 123.

However, it is further understood that any instructions to implement method 600 may be encoded at any suitable non-transitory machine-readable storage medium, including, but not limited to, the memory 322 and/or the memory 122, and that instructions to implement method 600 may be executable by any suitable processor of any suitable printing device

Beginning at a block 601, the processor 320 communicates with the sensor 307 to determine that a trailing paper edge has passed the sensor 307 and the reflective surface 309. As described above, the sensor 307 is to: emit light 360 towards the reflective surface 309 along the paper path 303 of the printing device 301; and detect light 361 reflected from the reflective surface 309, the sensor 307 and the reflective surface 309 on opposite sides of the paper path 303 such that paper 304 moves along the paper path 303 between the sensor 307 and the reflective surface 309.

At a block 603, the processor 320, after the trailing paper edge is detected, communicates with the sensor 307 to determine that the light 361 detected by the sensor 307, as reflected by the reflective surface 309, meets a moisture threshold condition 324.

At a block 605, the processor 320, in response to determining that the light 361 detected by the sensor 307 meets the moisture threshold condition 324, controls the component 305 of the printing device 301 to cause reduction of the moisture 350, 351 along the paper path 303.

It should be recognized that features and aspects of the various examples provided above may be combined into further examples that also fall within the scope of the present disclosure.

1. A printing device comprising:
a paper path;
a component controllable to cause reduction of moisture along the paper path;
a sensor and a reflective surface on opposite sides of the paper path such that paper moves along the paper path between the sensor and the reflective surface, the sensor to: emit light towards the reflective surface; and detect light reflected from the reflective surface; and
a processor connected to the sensor and a memory storing instructions, the processor to execute the instructions to cause the processor to:
communicate with the sensor to determine that the light detected by the sensor, as reflected from the reflective surface, meets a moisture threshold condition; and
in response to determining that the light detected by the sensor meets the moisture threshold condition, control the component to reduce the moisture along the paper path.

2. The printing device of claim 1, wherein the moisture threshold condition comprises:
a given intensity of the light reflected by the reflective surface.

3. The printing device of claim 1, wherein the moisture threshold condition comprises:
a rate of change of the light reflected by the reflective surface.

4. The printing device of claim 1, wherein the component is to control a rate of movement of the paper along the paper path to cause reduction of the moisture along the paper path, and the instructions are further to cause the processor to:
in response to determining that the light detected by the sensor meets the moisture threshold condition, control the component to slow the rate of movement of the paper along the paper path to cause reduction of the moisture along the paper path, until the light detected by the sensor meets a lowered moisture threshold condition.

5. The printing device of claim 1, wherein the component is to pause movement of the paper along the paper path to cause reduction of the moisture along the paper path, and the instructions are further to cause the processor to:
in response to determining that the light detected by the sensor meets the moisture threshold condition, control the component to pause movement of the paper along the paper path to cause reduction of the moisture along the paper path, until the light detected by the sensor meets a lowered moisture threshold condition.

6. A non-transitory machine-readable storage medium encoded with instructions executable by a processor of a printing device, the instructions to control the processor to:
communicate with a sensor to determine that a trailing paper edge has passed the sensor and a reflective surface, the sensor to: emit light towards the reflective surface along a paper path of the printing device; and detect light reflected from the reflective surface, the sensor and the reflective surface on opposite sides of the paper path such that paper moves along the paper path between the sensor and the reflective surface;
after the trailing paper edge is detected, communicate with the sensor to determine that the light detected by the sensor, as reflected by the reflective surface, meets a moisture threshold condition; and, in response,
control a component of the printing device to cause reduction of moisture along the paper path.

7. The non-transitory machine-readable storage medium of claim 6, wherein the component comprises a heater to heat the paper for printing thereupon, and the instructions are further to cause the processor to:
lower a temperature of the heater to control the component of the printing device to cause reduction of the moisture along the paper path.

8. The non-transitory machine-readable storage medium of claim 6, wherein the component comprises a fan, and the instructions are further to cause the processor to:
increase a speed of the fan to control the component of the printing device to cause reduction of the moisture along the paper path.

9. The non-transitory machine-readable storage medium of claim 6, wherein the component comprises a fan, and the moisture threshold condition comprises a rate of change of the light detected by the sensor, and the instructions are further to cause the processor to:
control a speed of the fan as a function of the rate of change of the light detected by the sensor to control the component of the printing device to cause reduction of the moisture along the paper path.

10. The non-transitory machine-readable storage medium of claim 6, wherein the moisture threshold condition comprises a rate of change of the light detected by the sensor, and the instructions are further to cause the processor to:
after each of a plurality of trailing paper edges are detected, communicate with the sensor to determine a respective rate of change of the light detected by the sensor; and, in response,
control the component of the printing device as a function of the respective rate of change of the light to cause reduction of the moisture along the paper path.

11. A printing device comprising:
a paper path;
a motor to control a rate of paper along the paper path;
a sensor and a reflective surface on opposite sides of the paper path such that paper moves along the paper path between the sensor and the reflective surface, the sensor to: emit light towards the reflective surface; and detect light reflected from the reflective surface; the paper that moves along the paper path to intermittently interrupt the light reflected by the reflective surface to the sensor; and
a processor connected to the sensor and a memory storing instructions, the processor to execute the instructions to cause the processor to:
after trailing edges of the paper are detected by the sensor via a change in the light detected at the sensor, communicate with the sensor to determine that the light detected by the sensor, as reflected by the reflective surface, meets a first moisture threshold condition; and
in response to determining that the light detected by the sensor meets the first moisture threshold condition, control the motor to reduce the rate of the paper along the paper path or pause the paper along the paper path, to reduce the moisture along the paper path, until the light detected by the sensor, as reflected by the reflective surface, meets a second moisture threshold condition.

12. The printing device of claim 11, wherein the first moisture threshold condition comprises a first given intensity of the light detected by the sensor, and the second moisture threshold condition comprises a second given intensity of the light detected by the sensor, the second given intensity indicative of more of the light reflected by the reflective surface than the first given intensity.

13. The printing device of claim 11, wherein the first moisture threshold condition comprises a first rate of change of the light detected by the sensor, and the second moisture threshold condition comprises a second rate of change of the light detected by the sensor, the first rate of change of the light detected by the sensor indicative of a decrease of the light reflected by the reflective surface and the second rate of change of the light detected by the sensor indicative of an increase of the light reflected by the reflective surface.

14. The printing device of claim 11, wherein the instructions are further to cause the processor to:
control the motor to control the rate of the paper along the paper path as a function of a rate of change of the light detected by the sensor, as reflected by the reflective surface.

15. The printing device of claim 11, wherein the instructions are further to cause the processor to:
control a notification device to indicate control of the motor to reduce the moisture along the paper path.
